(19) United States
(12) Patent Application Publication
(10) Pub. No.: US 2015/0294345 A1
(43) Pub. Date: Oct. 15, 2015

(54) PRESENTATION OF PURCHASING INCENTIVES

(71) Applicant: International Business Machines Corporation, Armonk, NY (US)

(72) Inventors: Ajay Ashok DESHPANDE, White Plains, NY (US); Kimberly D. HENDRIX, New Albany, OH (US); Herbert Scott MC FADDIN, Yorktown Heights, NY (US); Chandrasekhar NARAYANASWAMI, Wilton, CT (US)

(73) Assignee: INTERNATIONAL BUSINESS MACHINES CORPORATION, Armonk, NY (US)

(21) Appl. No.: 14/749,721

(22) Filed: Jun. 25, 2015

Related U.S. Application Data
(63) Continuation of application No. 14/530,050, filed on Oct. 31, 2014.
(60) Provisional application No. 61/897,977, filed on Oct. 31, 2013.

(51) Int. Cl. G06Q 30/02

(52) U.S. Cl. CPC G06Q 30/0235

(57) ABSTRACT

Methods for creating a presentation of purchase incentives to a shopper. A presentation to present to a shopper is created. A depiction of a store layout is depicted on the presentation, where the store layout depicts a plurality of areas with each area being associated with a respective set of associated items within a plurality of items offered for purchase. A respective depiction is depicted, on the presentation of the store layout, for each of at least one purchase incentive. Each purchase incentive has a respective associated item within a plurality of items offered for purchase. The respective depiction is graphically linked to a respective area that is associated with the respective associated item.

### BACKGROUND

The present disclosure generally relates to the field of identifying and presenting purchasing incentives to customers, and more particularly to presenting purchasing incentives along with locations of associated items within a presentation of a store layout.

Purchasing incentives, such as discount coupons, notifications of discounts, and other information relevant to a purchasing decision, are offered by retailers in print leaflets, flyers, at the point of sale or on websites to provide incentives to customers to buy products. Sometimes discounts or other information are displayed for some products at locations in the store near products, such as on store racks. Using purchasing incentives, such as discount coupons, presented in leaflets or fliers may require the purchaser to spend effort in searching through many coupons for all kinds of products to find coupons for products of interest to that customer. Coupon selection through the above techniques can be cumbersome for the shopper and does not offer the best customer experience, causing some consumers to ignore available offers. Monitoring coupon redemption history allows a retailer to learn about consumers buying habits through their purchase history and redemption of certain types of incentives.

### BRIEF SUMMARY

In one example, a method for creating a presentation of purchase incentives to a shopper includes creating a visually relevant presentation to a shopper. A depiction of a store layout is depicted on the presentation, where the store layout depicts a plurality of areas with each area being associated with a respective set of associated items within a plurality of items offered for purchase. A respective depiction is rendered on the presentation of the store layout for each of at least one purchase incentive. Each purchase incentive has a respective associated item within a plurality of items offered for purchase. The respective depiction is graphically linked to a respective area of the store that is associated with the respective associated item.

In another example, a device for creating a presentation of purchase incentives to a shopper includes a presentation creation apparatus that creates a presentation. The created presentation includes a depiction of a store layout that depicts a plurality of areas. Each depicted area is associated with a respective set of associated items within a plurality of items offered for purchase. The created presentation further includes a respective depiction, with the depiction of the store layout, for each of at least one purchase incentive. Each purchase incentive has a respective associated item within the plurality of items offered for purchase. The respective depiction being graphically linked to a respective area that is associated with the respective associated item.

In yet another example, a computer program product for creating a presentation of purchase incentives to a shopper, includes a storage medium readable by a processing circuit and storing instructions for execution by the processing circuit for performing a method. The method includes creating a presentation to present to a shopper and depicting, on the presentation, a depiction of a store layout. The store layout depicting a plurality of areas, each area being associated with a respective set of associated items within a plurality of items offered for purchase. The method further includes depicting, on the presentation, a respective depiction, on the store layout, for each of at least one purchase incentive, each purchase incentive having a respective associated item within the plurality of items offered for purchase, the respective depiction being graphically linked to a respective area that is associated with the respective associated item.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various examples and to explain various principles and advantages all in accordance with the present disclosure, in which:

FIG. 1 illustrates a store layout, according to one example;

FIG. 2 illustrates a shopping tour and incentive depiction, in accordance with an example;

FIG. 3 illustrates an electronic store layout presentation interface, according to an example;

FIG. 4 illustrates a purchasing incentive presentation system, according to an example;

FIG. 5 illustrates an incentive selection and presentation process, according to an example;

FIG. 6 illustrates a shopping path display process, according to an example;

FIG. 7 illustrates a purchasing incentive value varying process, according to an example;

FIG. 8 illustrates a limited purchasing incentive offer process, according to an example; and

FIG. 9 is a block diagram illustrating one example of an information processing system according to one example.

### DETAILED DESCRIPTION

Below are described systems and methods for presenting available purchasing incentives, such as coupons/discounts, that are matched with the spatial distribution of the available product inventory in the store. The shopper is presented with a view of a subset of these purchasing incentives, such as coupons, online or on paper augmented with the store layout, which is familiar to the shopper. The presentation of the purchasing incentives is also able to be incorporated into a gamification process. Examples of gamification processes include limiting a number of available purchasing incentives, and/or providing surprise appearances of purchasing incentives as a customer journeys through the store layout with or without a record of the customer's prior purchase history. The purchasing incentive presentations in some examples described below, which present purchasing incentive information in association with departments or areas of a store containing an item with the purchasing incentive, provide an easy and intuitive view of the purchasing incentives to the shopper. In some examples, the shopper's response to being offered particular purchasing incentives, such as the shopper's selecting to see more information concerning the purchasing incentives, can be monitored to assist in determining interests and potential purchase patterns of the user. Such interests and potential purchase patterns are able to be used to select further purchasing incentives to provide to that shopper. Depictions of purchasing incentives in some examples are able to be summarized by grouping purchasing incentives that are available in a particular department or section of a store, and only a glimpse of available purchasing incentives is displayed to the shopper. Such a glimpse encourages the shopper to visit the store or department to learn more about the purchasing incentives and associated items.

The following description refers to providing purchasing incentives to a shopper. In general, purchasing incentives are able to be any incentive provided to a person to provide a motivation for that person to purchase a particular product. The purchasing incentive may further provide an incentive to purchase the product from a particular retailer or store. In the following discussion, a purchasing incentive is said to be offered to a shopper when the terms of the purchasing incentive are presented to the shopper in a manner that allows the shopper to select the purchasing incentive. As used in some examples below, a purchasing incentive is offered to the shopper by displaying text describing a discount or other incentive to purchasing a particular product. Examples of a shopper selecting a purchasing incentive as described below include, for example, clicking on a depiction of the purchasing incentive or “clipping” a printed coupon. The following description refers to a shopper satisfying the conditions of the purchasing incentive, and thereby receiving the benefit of the purchasing incentive, as redeeming the purchasing incentive. In an example of a conventional “discount coupon,” a shopper redeems the discount coupon by purchasing the product identified on the coupon and presenting the coupon at the time of purchase in order to have the discount specified on the coupon applied to that purchase transaction. In the case of shopping facilitated by electronic equipment associated with the purchaser, such as in an online shopping experience or shopping in a physical brick-and-mortar store with a smartphone or store provided device such as a product scanner, store display, kiosks, or other device, a shopper is able to select the purchasing incentive through the electronic device, have the purchasing incentive associated with his or her account, and have the benefit of accepted purchasing incentives automatically applied when its associated conditions are met, such as when purchasing a product associated with the purchasing incentive.

The following description refers to items associated with a purchasing incentive. In one example, a purchasing incentive provides a discount for the purchase of a particular item or a group of specified items. Such items are said to be associated with the purchasing incentive. In general, any item or service that is part of a condition for receiving a benefit of the purchasing incentive is referred to as an item associated with the purchasing incentive. In some examples, purchase of the item associated with the purchasing incentive is not required to receive a benefit of the purchasing incentive.

In the following description, any entity participating in providing or offering the purchasing incentive to shoppers is referred to as a promoter. Examples of promoters include manufacturers of a product associated with a purchasing incentive, a retailer offering the purchasing incentive, any other entity with an interest in a promotion associated with the purchasing incentive, or combinations these.

The below described systems and methods allow offering purchasing incentives when a shopper is interacting with a retailer or other promoter in a variety of ways. For example, various examples allow a shopper to select purchasing incentives, such as coupons, in an online interaction with a retailer where the shopper is presented with a virtual store layout, or the shopper is able to select purchasing incentives, such as coupons, that are printed on a paper or other hardcopy on pictorial layout. Once a shopper has selected a purchasing incentives through these or other techniques, the shopper in some examples is able to shop for items associated with the purchasing incentives through, for example, either an online shopping experience or by visiting a brick-and-mortar store.

In online shopping examples, a virtual walking tour like experience can be created which encourages shoppers to follow their typical store route for purchasing incentive selection. Monitoring the shopper's path helps to gain information about a particular shopper's typical route and helps the retailer promote products at places of interest to that shopper. Also, the tour can be arranged such that the shopper visits sections that the shopper has not previously visited or has not often visited.

Additional gamification techniques can be applied to make the purchasing incentive selection more fun and learn more about consumers. In some examples, the number of purchasing incentives that can be selected by a shopper is limited, or the period of time during which a particular purchasing incentive applies to shoppers is limited. In some examples, these limited number or offer time purchasing incentives are able to be targeted to particular shoppers based upon that shopper's determined preferences. In some examples with electronic displays, pop up depictions of particular purchasing incentives are able to be put on the electronic display when the shopper visits or is near a certain area/department of a store. Such pop up depictions are able to help the shopper learn more about these departments. The promoter, such as the retailer, is able to learn more about the shopper's interested in different departments or areas of the store based on the shopper's location, and also by any interaction that the shopper may have with the pop up depictions, such as clicking on or hovering over those depictions after they are displayed. Multiple user games are also able to be organized to enable groups of shoppers to coordinate, compete, or otherwise interact in the selection of purchasing incentives. In some examples, multiple user games may offer more valuable purchasing incentives to groups that satisfy certain conditions, such as a total number of purchasing incentives selected and/or redeemed, or based other criteria.

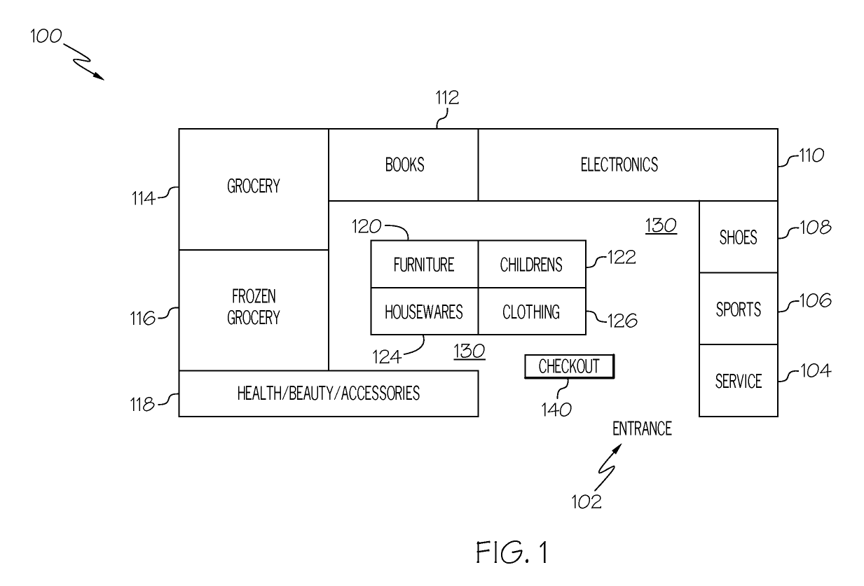

FIG. 1 illustrates a store layout 100, according to one example. The store layout 100 is an example of a depiction of a self-service shopping layout that is presented to a user. The store layout 100 depicts a number of departments that are disposed at various locations in the store. The depicted departments are examples of areas of a store layout where each department, or area, is associated with a set of items that are offered for purchase. Walkways 130 are depicted to separate some departments and allow a shopper to move about the store to reach the various departments. The store layout 100 shows a sports department 106, a shoes department 108, an electronics department 110, a books department 112, a grocery department 114, a frozen grocery department 116, a health/beauty accessories department 118, a furniture department 120, a children's department 122, a housewares department 124, and a clothing department 126. Each of these departments reflects a type of merchandise or items that is offered for purchase in that department. As is well known in department stores, organizing merchandise into departments makes it easy for a shopper to find items of interest during a shopping visit, though there can be cases of cross-merchandising that apply as well.

In addition to the merchandise departments, the store layout 100 depicts an entrance 102 where a shopper begins his or her visit, and a checkout area 140 is shown which is where a shopper goes to finish the shopping visit and pay for purchases. A service department 104 is shown as a location where a shopper is able to go at any time for help or other customer service functions. The store layout 100 allows a shopper to identify where he or she is in the store at a given time and to further identify areas of the store where he or she would want to go to buy items of interest. Such a depiction is able to be presented to a shopper either in a printed form or on an electronic device, such as a tablet, smartphone, a product scanner, store display, kiosks, or other devices located in the store or that the shopper is able to take along during a shopping visit. Other presentations of the store layout 100 are also able to be used to assist a shopper.

In some examples, a presentation of the store layout 100 is able to be presented during an on-line shopping experience, such as on a web browser, so that a shopper is able to quickly and easily find items of interest by narrowing down offerings by the category of desired merchandise. Purchasing incentives being offered to the shopper are also able to be organized according to the department of the item associated with the purchasing incentive and selection of a department is able to produce a list of purchasing incentives offered for items offered in the selected department. Presenting an online shopper with a familiar store layout can further help the shopper quickly and easily find listings for products, purchasing incentives, or both.

In an example, a brick-and-mortar retailer is able to provide an online shopping portal that presents, as part of the online shopping experience, a store layout 100 that corresponds to a typical layout of a brick-and-mortar location of that same retailer. In some examples, a shopper visiting an online shopping portal of a retailer that also has brick-and-mortar stores in the area of the shopper are presented with a store layout 100 corresponds to the floor plan of that retailer's brick-and-mortar store that is closest to that shopper or of a brick and mortar store for which the shopper has indicated a preference, such as through a profile selection or as evidenced by previous shopping visits. Such personalization of the store layout 100 presented to an online shopper provides that shopper with a familiar store layout from which to locate items of interest, and is also able to strengthen the shopper's affinity to the retailer by reinforcing the shopper's familiarity with the store layout through both physical store visits and virtual shopping experiences.

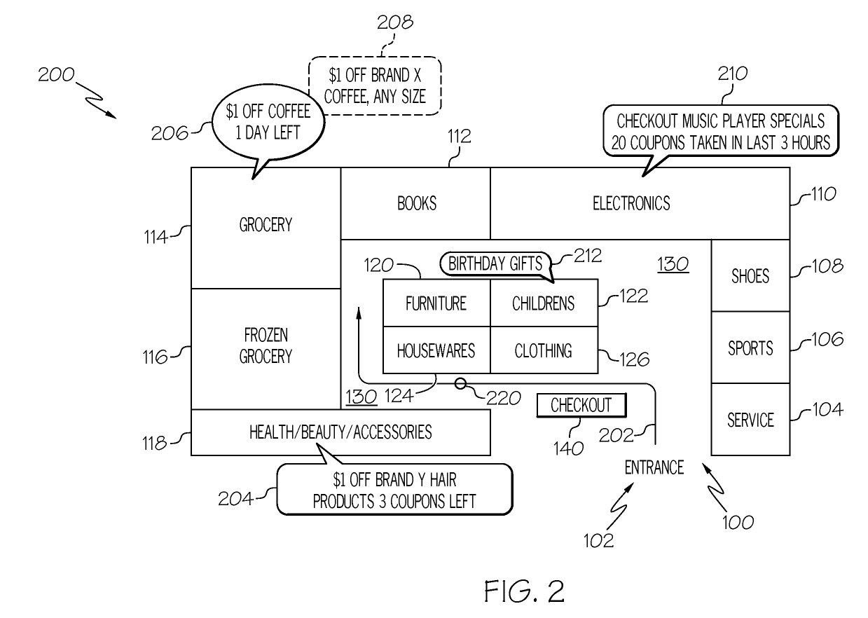

FIG. 2 illustrates a shopping tour and incentive depiction 200, in accordance with an example. The shopping tour and incentive depiction 200 includes the above described store layout 100 to which a virtual shopping tour path 202 is added along with a number of available purchasing incentives that are organized by the department of the item associated with the purchasing incentive. In various examples, the depictions of the purchasing incentives are able to be added to the store layout 100 based upon various conditions. For example, depictions of purchasing incentives are able to be presented all at once either upon an initial presentation of the store layout 100 or based on a user input that indicates all purchasing incentives should be shown. In another example, depictions of purchasing incentives are able to be presented based on a user selection of, for example, a department for which depictions of purchasing incentives are to be displayed. In the case of a user input, or other condition, indicating that purchasing incentives for particular departments are to be shown, only the purchasing incentives for the selected departments are depicted. In another example, depictions of purchasing incentives are able to be displayed as a shopper navigates through the store layout 100 by various techniques, as are described below.

The shopping tour and incentive depiction 200 illustrates several purchasing incentive depictions. A first purchasing incentive 204 states “$1 Off Brand Y Hair Products—3 Coupons Left.” The first purchasing incentive 204 is for a hair product, which is associated with the Health/Beauty/Accessories department 118. The first purchasing incentive 204 is therefore depicted as being associated with the Health/Beauty/Accessories department 118 by being a bubble with a pointer to that department on the store layout 100. The first purchasing incentive 204 further indicates that there are only 3 coupons remaining at a point in time for that offer. Including a number of coupons remaining to be obtained for the offered purchasing incentive provides a sense of urgency in causing the shopper to select that purchasing incentive if the shopper is interested in that offer. The urgency in selecting the offer increases the likelihood that a shopper will select a purchasing incentive offer that is of interest rather than postpone a decision to select the offer. Increasing the likelihood of selecting offers of interest in this way enhances shopper's preference information about the shopper and aids in providing relevant incentives to the shopper in the future.

A second purchasing incentive 206 states “$1 off Coffee—1 Day Left.” The second purchasing incentive 206 is for coffee, which is associated with the Grocery department 114 and therefore the second purchasing incentive 206 is depicted as being associated with the grocery department 114 by being a bubble with a pointer to that department on the store layout 100. The second purchasing incentive 206 indicates that there is only one day left for that offer. Adding such a time limitation similarly adds the sense of urgency discussed above with regards to the first purchasing incentive 204 and is able to provide similar benefits. The second purchasing incentive 206 does not identify the brand of coffee or other information about the offer. In this example, the second purchasing incentive 206 is configured to provide additional information about the purchasing incentive offer in a pop-out bubble 208. The pop-out bubble 208 in this example is displayed based on a user selecting or otherwise indicating an interest in the second purchasing incentive 206. In an example of an electronically displayed shopping tour and incentive depiction 200, the pop-out bubble 208 is displayed when a user clicks on, taps, and/or hovers over the second purchasing incentive 206. In this example, the pop-out bubble describes the brand and product size for which the purchasing incentive offer is valid.

A third purchasing incentive 210 includes text to pique the interest of the shopper and only indicates a general category of merchandise. In the illustrated example, the third purchasing incentive 210 indicates “Checkout Music Player Specials—20 Coupons Taken in Last 3 Hours.” The text of the third purchasing incentive 210 suggests that further information is available about the purchasing incentive and that clicking on or otherwise selecting the depiction of the purchasing incentive will trigger further information to be provided. Such further information may be presented in an additional display (not shown) or in a pop-up bubble (not shown). The third purchasing incentive 210 also indicates that “20 coupons were taken in Last 3 Hours.” The time statement and coupon number listing suggests that there are a limited number of coupons available for this purchasing incentive offer, and that this offer may be time limited, even if these situations are not true. Such text can increase the urgency or social proof to select the offer and provide the above described benefits. The listing of a number of coupons already accepted is able to add a gamification aspect to the shopping experience, whereby this data suggests a competition to obtain more coupons or indicates a popularity of the purchasing incentive offer to other shoppers.

A fourth purchasing incentive 212 states “Birthday Gifts” and is associated with the Children's department 122 by being a bubble with a pointer to that department on the store layout 100. In this example, a database is maintained with a personal profile for the particular shopper to whom the shopping tour and incentive depiction 200 is being presented. This personal profile data indicates in this example that this particular shopper has children with upcoming birthdays. Based on the information in the personal profile for that shopper, the fourth purchasing incentive is presented to that shopper to suggest his or her purchasing gifts for that child's upcoming birthday. Such purchasing incentives are referred to herein as event-driven purchasing incentives. In various examples, events for which purchasing incentives are presented to a shopper include events indicated based upon a personal profile for that shopper, upcoming holiday or other seasonal event, current weather conditions and weather forecasts, other events, or combinations of these.

The shopping tour and incentive depiction 200 illustrates a tour path 202 that depicts a travel path along which a shopper is able to travel during a shopping visit. The tour path 202 is an example of a travel route and is able to serve as an indicator of a suggested path for the shopper through the store layout or is able to indicate a path taken by the shopper through the store layout. In various examples, the shopping tour and incentive depiction 200 is able to reflect a display presented to a shopper visiting a physical brick-and-mortar store location, such as would be displayed on a computing tablet, smartphone, a product scanner, store display, kiosks, or other devices located in the store or other display device carried by the shopper, or the shopping tour and incentive depiction 200 is able to be presented as part of an online shopping experience where the tour path 202 is able to reflect a path suggested to the shopper, or is able to depict a path already taken by the shopper during the online shopping experience.

A tour path 202 that is presented to a shopper as a suggested tour path is able to be created based upon various factors, such as directing the shopper through an efficient shopping path to obtain items of interest based on the shopper's purchase history; directing the shopper to visit departments having items of interest based on extrinsic conditions such as weather, season of the year, upcoming holidays, or combinations of these; directing the shopper to visit departments with purchasing incentives directed to the shopper based on shopper characteristics such as purchasing history, demographics, other characteristics, or combinations of these; or based on any other criteria. The tour path 202 is also able to be based on particular promotions offered by the retailer so that the shopper is directed to visit departments associated with those promotions. In the various examples, the tour path 202 is able to reflect a physical path through a brick-and-mortar store or a virtual path that can by followed to visit different departments depicted in a virtual store layout 100 presented as part of an online shopping experience. In some examples, a shopper is able to have a shopping list that contains items the shopper may be interested in purchasing. Shopping lists are able to be created by the shopper, are able to be automatically generated based on shopper characteristics such as preferences, based on other techniques, or combinations of these. A created tour path 202 is able to be based in part or completely upon such a shopping list for the shopper, where the tour path 202 passes by items on the shopping list, a location of those items, other locations associated with the items, or combination of these.

The shopping tour and incentive depiction 200 indicates a shopper's present location 220. The shopper's present location 220 in one example is able to reflect the shopper's present location in a physical, brick-and-mortar store, such as would be determined by shopper tracking equipment using various technologies. Alternatively, in an example including an online shopping experience, the shopper's present location 220 is able to be a virtual location that reflects a fictitious location of the shopper within the virtual retailer. The use of a “present location” metaphor is able to be a basis for selecting information to present to the shopper. For example, information can be selected to be presented to the shopper for items located in, i.e., associated with, the departments that are in proximity to the shopper's present location 220 according to the store layout 100. In the illustrated example, the shopper's present location 220 is between the Housewares department 124 and the Health/Beauty/Accessories department 118. In this example, purchasing incentives for items that are in the Housewares department 124, the Health/Beauty/Accessories department 118, or both departments can be presented to the shopper. Further, pop-out bubbles, such as the pop-out bubble 208 associated with the second purchasing incentive 206, is able to be presented based upon the present location of the shopper being near the department associated with that purchasing incentive. Further information that is associated with purchasing incentives that suggest the availability of further information, such as the third purchasing incentive 210 described above, may be presented to the shopper as the shopper's present location approaches the depiction of that purchasing incentive, or as the shopper approaches the department with that purchasing incentive.

In one example, an online shopping experience is able to include a presentation of the shopping tour and incentive depiction 200 and as the shopper's present location approaches or is near a particular department, a selection of merchandise associated with that department is presented to the shopper such that the shopper is able to select items to purchase. Various techniques are known for presenting merchandise to an online shopper and receiving input from the shopper to select particular items to purchase. The shopping tour and incentive depiction 200 further allows an online shopper to select one or more purchasing incentives through various selection techniques, such as clicking on or otherwise selecting the depiction of the purchasing incentive as described above, or by selection through other techniques. Such purchasing incentives selected by the shopper are then associated with the shopper to be applied to purchases of items associated with the selected purchasing incentives.

Other aspects of the shopping tour and incentive depiction 200 include the depiction of a checkout area 140. In an example of an online shopping experience, the shopper is able to indicate movement to the checkout area 140 to end the shopping process and complete purchase transactions for selected merchandise. The purchase transactions for the selected items are able to be accomplished by any suitable technique. In various examples, the purchase transaction also applies purchasing incentives selected by the shopper that are associated with items being purchased.

A Service Department 104 is further depicted on the shopping tour and incentive depiction 200. In an example of an online shopping experience, an online shopper is able to receive assistance or otherwise receive any suitable type of customer service by, for example, navigating to the service department 104 by a suitable technique, and a customer service interaction mechanism is triggered.

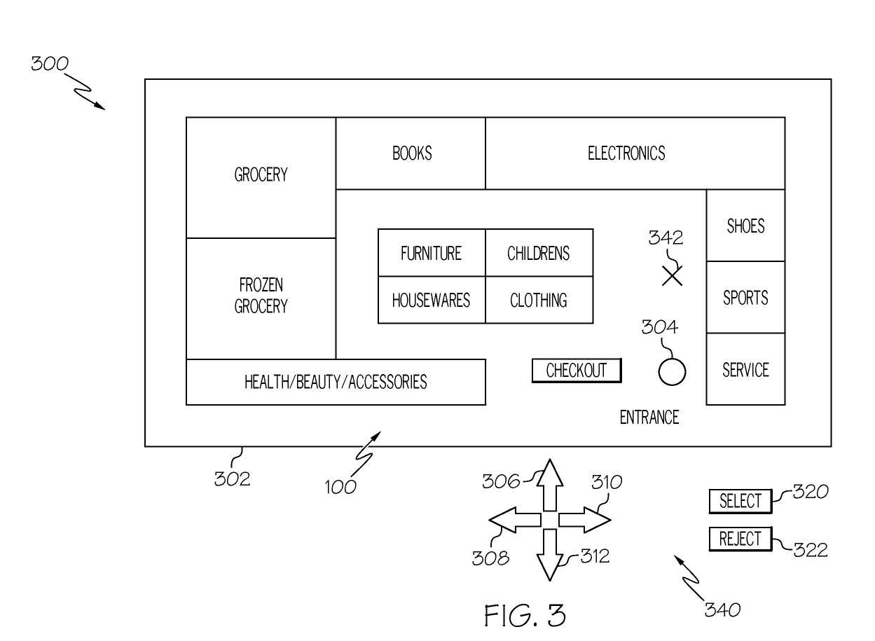

FIG. 3 illustrates an electronic store layout presentation interface 300, according to an example. The electronic store layout presentation interface 300 is an example of an electronic user interface device that presents a depiction of the store layout 100 and its augmentation described in the shopping tour and incentive depiction 200. A store layout electronic display 302 is shown that includes the store layout 100 along with a shopper icon 304. In various examples, the shopper icon represents a location of the shopper in the store that corresponds to the store layout 100. In various examples, the electronic store layout presentation interface 300 is able to be used by a shopper who is physically in a brick-and-mortar store, or the electronic store layout presentation interface 300 is also able to be presented in association with an online shopping experience to present a virtual store visit.

The illustrated electronic store layout presentation interface 300 includes a number of user input buttons 340. The user input buttons 340 include directional buttons including an up button 316, a left button 308, a down button 312, and a right button 310. These directional buttons are able to be used, for example, in an online shopping experience to navigate through a virtual store. In a physical, brick and mortar store, the directional buttons are able to be used to allow the shopper to move an information icon 342 to obtain information about other departments without physically moving to those departments.

The user input buttons 340 further include a “Select” button 320 and a “Reject” button 322. These buttons are able to be used, for example, to select or reject, respectively, a purchasing incentive offer. In some examples, additional information about a purchasing incentive is provided based on a shopper pressing the “Select” button 320.

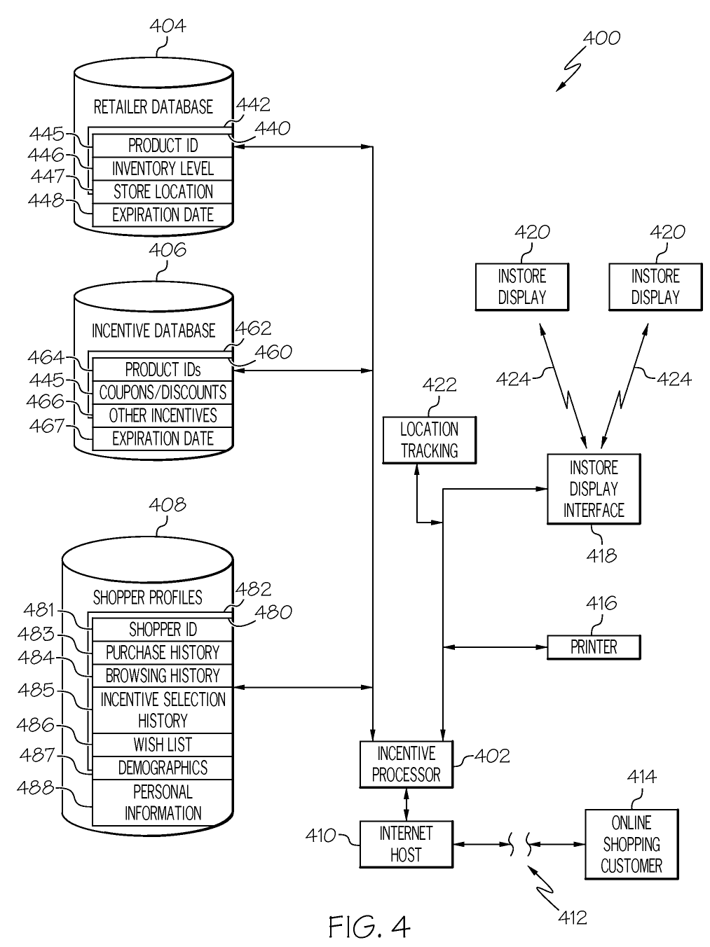

FIG. 4 illustrates a purchasing incentive presentation system 400, according to an example. The purchasing incentive presentation system 400 is an example of a data processing and user interface infrastructure that is suitable for performing aspects of the methods described herein. In one example, the purchasing incentive presentation system 400 is operated by a retailer with both physical brick-and-mortar stores and also with an Internet retail presence to allow shoppers to select and purchase items, along with receiving purchasing incentives, online in addition to physically visiting brick-and-mortar stores. In other examples, the purchasing incentive presentation system 400 is able to be operated by an online retailer, a retailer with conventional brick-and-mortar retail locations.

The purchasing incentive presentation system 400 includes an incentive processor 402 that is configured to identify purchasing incentives to provide to shoppers based on various criteria, as is described for example in further detail below. In one example, the incentive processor offers shoppers purchasing incentives based upon one or more of shopper's preference information as determined from various sources, inventory levels of particular products at the retailer, extrinsic information such as current or predicted weather, upcoming holidays, local events, promotions or other purchasing incentives available at other retailers, or other criteria.

The incentive processor 402 in various examples is connected to an internet host 410, which provides an internet portal through an internet connection 412 for an online shopping customer 414 to shop online. Although only one online shopping customer 414 is illustrated, it is clear that any number of remote users are able to shop through the retailer's internet host 410. The online shopping customer is able to use any suitable device and configuration to access the internet host 410, such as a computer with a web browser, a portable computing device executing a application, or “app,” that is configured to efficiently operate with software operating on the internet host 410. The online shopping customer 414 is also able to communicate with the internet host 410 in any suitable manner, including via a wide area network such as the Internet, a dedicated communications channel, or any suitable communications channel.

The incentive processor 402 is also able to produce printed presentations of purchasing incentives through a printer 416. The printer 416 in various examples is a hardcopy printer that is able to print a single store layout 100 that includes presentation of selected purchasing incentives, including purchasing incentives that indicate location on the store layout 100 of a department associated with the respective purchasing incentive. In various examples, the printer 416 is used to print a personalized presentation of a store layout 100 that includes selected purchasing incentives that are directed to a particular customer of the retailer. The selected purchasing incentives are able to be selected based on, for example, purchasing histories of the shopper, inventory levels on-hand or other characteristics of the inventory (such as expiration dates of inventory items), current events and conditions such as weather or holidays, purchasing incentives offered by other retailers, any other selection criteria, or combinations of these. In some examples, a printed depiction of purchasing incentives is able to be produced in a brick-and-mortar store and given to the shopper upon his or her entrance to the store, the printed depiction of purchasing incentives can be sent to the shopper's home for use anytime or at a specific time, given to the shopper in any suitable manner, or combinations of these.

The incentive processor 402 further interacts with an in-store display interface 418 and a location tracking system 422. The in-store display interface 418 is in communication with one or more in-store display devices 420. The in-store display interface 418 and in-store display devices 420 in one example are equipment that is located within a brick-and-mortar store and that is used to provide directed purchasing incentives for items along with an indication of those items within the store. Other uses for an in-store display interface 418 and in-store display devices 420 are also possible. An example of an in-store display device 420 is described above electronic store plan presentation interface 300. Other types of in-store display interfaces 418 are also possible, including interfaces hosted on a shopper's personal device, such as a smart phone or tablet, on devices provided by the retailer such as a product scanner, store display, kiosks, other devices, or combinations of these.

The incentive processor 402 communicates with a location tracking system 422. The location tracking system 422 is able to determine locations of shoppers in a store and report those locations to the incentive processor 402. Various designs for location tracking systems that are able to track the locations of one or more shoppers in a store are able to be used in this example. For example, shopper location is able to be based upon location systems monitoring Wi-Fi signals from the shopper, Bluetooth signals from the shopper, GPS based location determinations for the shopper, cell signal strengths from the shopper, a user's scanning of an item in a known location, a store video camera, other location detecting devices, or combinations of these. The incentive processor is then able to select purchasing incentives to provide to each shopper based on that shopper's present location in the store. Newly selected purchasing incentives, which are selected based at least in part on the shopper's present location, are able to be provided to the shopper through, for example, an in-store display device 420, a communications device associated with the shopper, through any other technique, or combinations of these. In various examples, purchasing incentives are able to be selected based on combinations of factors that are able to include the shopper's present location. Other factors include a purchasing history of the shopper, preferences of the shopper that are determined by various sources, present or upcoming holidays, current or predicted weather, other factors, or combinations of these.

The purchasing incentive presentation system 400 includes a number of databases. The purchasing incentive presentation system 400 has a retailer database 404, an incentive database 406, and a customer profiles database 408. The incentive processor 402 accesses data stored in these databases in order to, for example, determine purchasing incentives to offer to a particular shopper. The data stored in these databases is able to originate from various sources, such as from shopper provided profile data, shopping history data compiled based upon prior purchases by the shopper at a retailer operating or accessing the incentive processor, from the retailer's inventory system, from any other suitable source, or from combinations of these. In an example, purchase history is able to be used to derive last purchase and historical purchase interval pattern for a particular product or item, and timing for offering purchasing incentives, such as discount coupons, can be based on such observations or derivations. In an example, purchase history is able to be used to derive last purchase and historical purchase interval pattern for a particular product or item, and timing for offering purchasing incentives, such as discount coupons, can be based on such observations or derivations.

The retailer database 404 stores information regarding the retailer's inventory. For example, the illustrated retailer database 404 includes a first product record 440 with fields for a product identifier 445, an inventory level 446, a store location 447, and an expiration date 448 that is stored in association with perishable items. The retailer database in various examples includes a number of records, such as the illustrated second record 442, where one record is maintained for each product carried by the retailer. Products are able to be distinguished by a product identifier, or Product ID, field which is able to include a Stock Keeping Unit (SKU) number, a Universal Product Code (UPC), a Price Look-Up code (PLU), other identification, or combinations of these. For each product identifier 445, an inventory level is also stored, which corresponds to the number of items the retailer has in inventory and available for sale. A store location 447 stores an indication of the location of the product in the retailer. In the case of a brick-and-mortar store, the store location 447 indicates the department in which the product is physically located. In an online shopping experience, the store location 447 is a virtual identification of a department with which the product is associated. In some configurations for online shopping, a product is able to have more than one store location stored in the retailer database 404.

The incentive database 406 stores information regarding purchasing incentives that are available to be offered to shoppers. The illustrated incentive database 406 is organized according to product identifiers for which purchasing incentives are available. A first purchasing incentive record 460 is illustrated and includes fields for a product identifier 464, one or more fields indicating coupons or discounts 465 for the associated product identifier 464, one or more fields indicating other purchasing incentives 466 for the product identifier 464, incentive cost data, and an expiration date and/or other conditions for the particular purchasing incentive. In various examples, a particular purchasing incentive record, such as the first purchasing incentive record 460, is able to have more than one of the illustrated fields, not have all of the illustrated fields, have other fields in addition to those shown, or contain any suitable set of information about a purchasing incentive. Each purchasing incentive is able to have a separate record in the incentive database 406, such as the illustrated second purchasing incentive record 462.

The shopper profiles database 408 stores information about each shopper registered with the retailer. The illustrated shopper profiles database 408 includes a record for each shopper, such as the first shopper record 480 and the second shopper record 482. The first shopper record 480 includes a shopper ID record 481, and a purchase histories field 483 that indicates purchase histories for the shopper. The purchase histories field 483 is able to refer to one or more other database records that detail earlier purchases made by the particular shopper. A browsing history field 484 is also stored in association with each shopper and in one example records items which the shopper had viewed in an online shopping experience or potentially in any online activity according to the configuration of the retailer's shopping history accumulation process. An incentive selection history field 485 is also stored in association with each shopper and records each purchasing incentive offer accepted by, and redeemed by, the shopper. Further records stored in association with the shopper include a wish list record 486, which stores items identified by the shopper as desired gifts and therefore are items in which the shopper has interest, and a demographics record 487 that stores shopper supplied information regarding the person's demographics.

In an example, the demographics record 487 has associated records indicated as personal information 488, which store information related to the individual's personal characteristics. The personal information 488 includes information such as the shopper's address, age, gender, income, number of household members, ages of other household members, gender of the shopper and other household members, occupation, other information, or any combination of these. The personal information contained within the demographics record 487 is also able to include a customer's propensity to try new products, e.g., their risk tolerance to experimenting with new products. The data stored in each shopper profile record is used in some examples to identify purchasing incentives to provide to the shopper. In an example, the shopper demographics record 487 is able to include indications of segments into which the shopper may be characterized, such as loyal shopper, growing shopper, or a dwindling shopper.

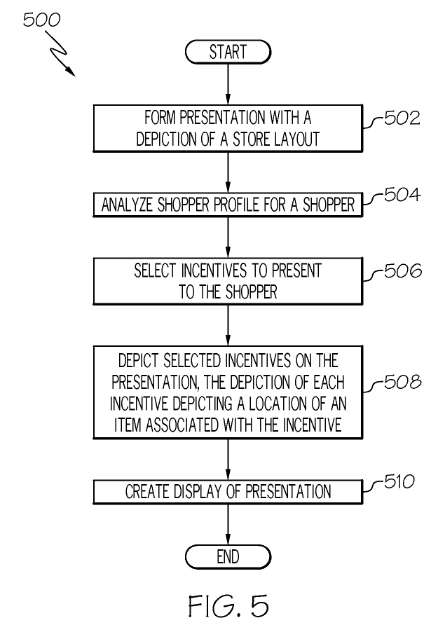

FIG. 5 illustrates an incentive selection and presentation process 500, according to an example. The incentive selection and presentation process 500 is an example of a process to create the shopping tour and incentive depiction 200, described above. In various examples, the incentive selection and presentation process 500 is able to create any type of purchasing incentive presentation where the purchasing incentives are presented with an indication of a location of items associated with the purchasing incentive and also where the purchasing incentives are selected based on the shopper's information.

The incentive selection and presentation process 500 begins by forming, at 502, a presentation with a depiction of a store layout. Such a presentation is described above with regards to store layout 100. A store layout is able to be formed based on any technique, such as retrieving a stored image of a stored layout. In various examples, the store layout is able to correspond to a physical layout of a brick-and-mortar store and depict the various departments present in such a store. In some examples, such as in an online shopping environment, the store layout is able to be a fictional construction that identifies departments familiar to shoppers to allow the shopper to quickly locate information on products the shopper is interested in shopping for. In an example of a store layout in an online example, the store layout is able to not actually correspond to a physical layout in which merchandise is located within a store, but is simply an organizational and presentation construct used to facilitate locating particular products in an online shopping experience by mimicking the familiar brick-and-mortar store shopping experience.

The incentive selection and presentation process 500 continues by analyzing, at 504, the shopper profile for a particular shopper. An example of a shopper profile is described above in regards to the customer profile database 408 of the purchasing incentive presentation system 400. As is described in further detail above, the shopper profile is able to store histories of prior purchases and prior redemptions of purchasing incentives. In various examples, new purchasing incentives that are likely to be accepted and redeemed by a particular shopper are able to be selected based on that shopper's histories of prior purchases and prior purchasing incentive redemptions.

Purchasing incentives to present to the shopper are selected, at 506. In some examples, such purchasing incentives are selected based upon an analysis of that shopper's profile, including, for example, purchasing histories, purchasing incentive selection and redemption histories, extrinsic information such as current or predicted weather, upcoming holidays, local events, events in the shopper's life such as a birthday, other criteria, or combinations of these. In an example, a shopper's purchase history is able to be used to derive last purchase and historical purchase interval pattern for a particular product or item, and timing for offering purchasing incentives, such as discount coupons, can be based on such observations or derivations. In an example, purchase history is able to be used to derive last purchase and historical purchase interval pattern for a particular product or item, and timing for offering purchasing incentives, such as discount coupons, can be based on such observations or derivations. Incentives offered to a shopper may also be based on an observation in the shopper's purchasing history that the shopper has not purchased items from a particular department, upon an observation that the shopper has never visited the department, such as by the location tracking system 422, or on other bases indicating that the shopper has not shown an interest in a particular department. In an example, a purchasing incentive is able to be provided to the shopper to encourage him or her to visit that department. In order to provide a stronger enticement to visit that department, a more valuable purchasing incentive, such as a coupon with a larger discount, is able to be offered. In general, only a subset of fewer than all available purchasing incentives is selected to be offered to a shopper based on the shopper's profile.

The selected incentives are depicted, at 508, on the presentation including the store layout that was created above, at 502. In one example, the depictions of purchasing incentives augment the presentation of the store layout. In further examples, a depiction of the purchasing incentives is able to be a presentation of a listing of purchasing incentives along with an indication of a department or other area of the presentation of the store layout. In such an example, there need not be a depiction graphically indication a displayed connection, such as a line, between the depiction of the purchasing incentive and the location of the item associated with the purchasing incentive on the store layout. The depiction of each purchasing incentive depiction indicates a location on the store layout of an item associated with that purchasing incentive. An example of an indication of the location of the item on the store layout is depicted with regards to shopping tour and incentive depiction 200, which depicts, for example, the first purchasing incentive 204 with a pointer to its associated department.

A display of the presentation of the store layout along with depictions of selected purchasing incentives is then created, at 510. The created display is able to be in any suitable form, such as a hardcopy printout, an electronic display, other presentation form, or combinations of these. The incentive selection and presentation process 500 then ends.

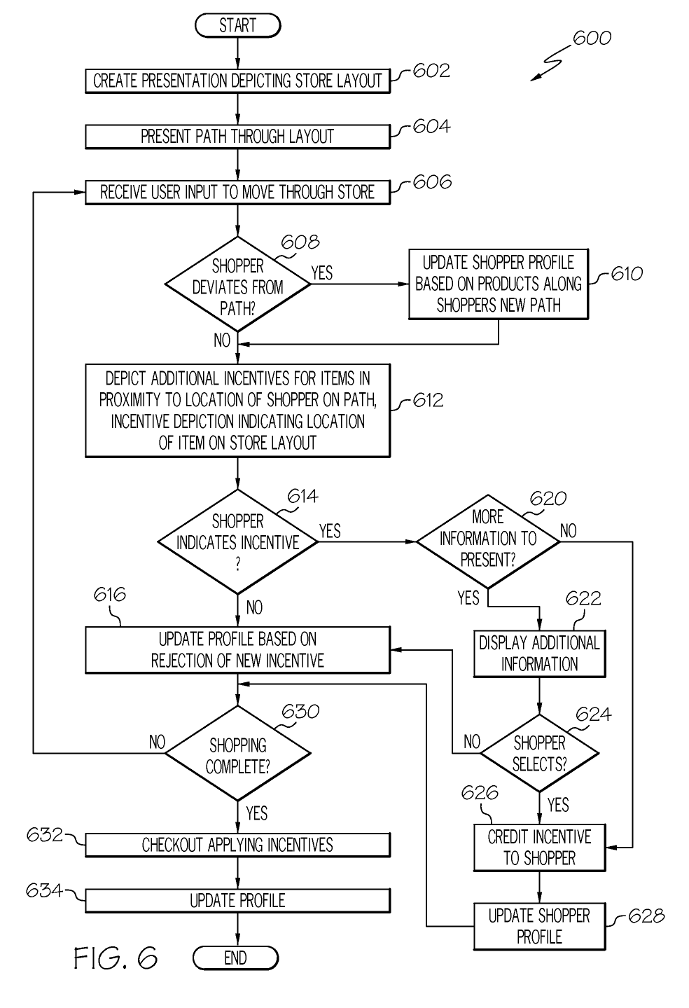

FIG. 6 illustrates a shopping path display process 600, according to an example. The shopping path display process 600 is an example of a process that creates a shopping tour and incentive depiction 200 and responds to inputs received through an interface such as the electronic store layout presentation interface 300.

The shopping path display process 600 creates, at 602, a presentation depicting the store layout. An example of such a depiction is shown in the store layout 100 discussed above with regards to FIG. 1. The data to create the depiction of the store layout is able to be stored in a memory as a figure or model of a store layout, or other techniques are able to be used to create the presentation of the store layout. In various examples, the presented store layout is able to reflect the physical layout of a brick-and-mortar store that the shopper is physically visiting, a fictional store layout for an online shopping experience where the store layout indicates departments in which items are categorized, or any other type of store layout.

A path is presented 604 through the store layout in some examples. The presented path is able to be a proposed path presented to the shopper as a route that the shopper would like to take through the store layout. Such a proposed path is able to be selected based upon, for example, information stored in a shoppers profile for the shopper, such as one or more of the shopper's purchasing histories indicating departments of interest for that particular shopper, available purchasing incentives, purchasing incentives which have been selected for the shopper, prior paths observed for the shopper through the store layout, indications provided by the shopper of items of interest for this particular shopping trip, any other criteria or combinations of these. In other examples, the presented path is also able to include, or even consist only of, the movements that the shopper has made through the store layout during this shopping visit.

User input is received, at 606, to move thought the store layout. The user input is able to be in any suitable form, such as user inputs provided through the electronic store layout presentation interface 300, or the user inputs may also include detected observations of actual user movements through a physical brick-and-mortar store such as are able to be determined by a location tracking system 422 discussed above with regards to purchasing incentive presentation system 400.

Determinations are made, at 608, of deviations of the shopper from a proposed path. In an example, a proposed path is provided through the store layout, and the shopper is presumed to generally follow that proposed path for his or her shopping. If the user deviates from this proposed path, the deviation may indicate a preference of the shopper and such a deviation is able to be incorporated into a determination or model of the shopper's interests in order to, for example, identify further incentives to offer to the shopper.

If a deviation from a proposed path is determined, the shopper's profile is updated, at 610, based on the shopper's new path. In one example, the update to the shopper's profile is able to be based on items that are located in departments along the shopper's new path. Such a deviation is further able to be combined with, for example, an online shopper's selection of one or more products along the new path, one or more purchases of products along the new path that are made by a shopper in a brick-and-mortar store, or other based on other aspects that are able to be inferred from the deviation in the path. In one example, the shopper's travel route through a store layout is determined based upon user inputs received from the shopper, such as in an online shopping experience or by monitoring a shopper's movements in a brick-and-mortar store.

The shopper's profile is then updated based upon the travel route indicated by those user inputs.

In general, the shopper's profile is able to be updated based upon any travel route taken by the shopper through the store layout regardless of how the travel route is determined. For example, a travel route taken by the shopper may be monitored without regard to a proposed path and the travel route taken by the shopper is used to update the shopper's profile.

Additional incentives are depicted, at 612, for items in proximity to a present location of the shopper on the path. The depiction of these additional incentives further indicates the location on the store layout of an item associated with the incentive. Such additional incentives are depicted in one example on an electronic display that a shopper carries on a shopping trip through a brick-and-mortar store, on an electronic display facilitating a shopper's online shopping experience, or on any other suitable depiction. In addition to offering additional incentives for an item based upon a shopper being in proximity to that item, in some examples additional incentives are able to be provided based upon a distance of the shopper from an item, such as how far the shopper is from a department with that item. In one example, the value of a purchasing incentive, such as a discount amount of a coupon, is able to be made higher if the shopper is farther from the item, thereby creating a draw or pull for the customer to at least visit the more distant department and investigate the product.

A determination is made to determine if the shopper indicates an interest in an incentive, at 614. In one example, a shopper interacting with a depiction of a purchasing incentive is taken as an indication of a shopper's interest in that purchasing incentive. A shopper's interest is able to be indicated by, for example, selecting the purchasing incentive or merely indicating an interest in the purchasing incentive. For example, indicating a shopper's interest in a purchasing incentive is able to include user interface inputs that cause hovering over a depiction of the purchasing incentive on a graphical user interface to have, for example, more information displayed. Shopper's interest in a purchasing incentive is also able to include the shopper's selecting the purchasing incentive, such as by clicking on the incentive or selecting “accept” on a depiction of the purchasing incentive, to have the purchasing incentive credited to the shoppers account. In either situation, various examples are able to update a shopper's profile based on any indication by a shopper of a purchasing incentive by inferring a shopper's interest in the purchasing incentive as a result of the indication.

If the shopper indicates an incentive, a determination is made if more information is to be presented as a result of the indication, at 620. As discussed above with regards to second purchasing incentive 206 in the shopping tour and incentive depiction 200, some purchasing incentives are able to be configured to display more information when they are indicated, such as the pop-out bubble 208 described above. If more information is to be displayed, the additional information is displayed, at 622. A determination is then made to determine if the shopper selected the purchasing incentive, at 624. If it is determined that the shopper did not indicate or select the purchasing incentive, at either 614 or 624, the shopper's profile is updated, at 616, to reflect rejection of the purchasing incentive. In some examples, a failure of a shopper to select a newly displayed incentive, such as the additional incentive depicted at 612, is noted in the shopper's profile and weighted differently that a failure to select other incentives.

If additional information is not to be displayed, as determined at 620, or the shopper selected the incentive, at 624, the incentive is credited to the shopper, at 626. Crediting a purchasing incentive to a shopper allows the shopper to redeem that purchasing incentive, such as by purchasing an item associated with the incentive or satisfying any other requirement of the purchasing incentive. The shopper's profile is updated, at 628, based on the shopper's selection of the purchasing incentive. In some examples, a shopper's profile is updated with all purchasing incentives selected by a shopper even if the shopper does not redeem the incentive. Redemption of purchasing incentives is also monitored and used to update shopper's profiles in various examples.

After updating a shopper's profile based on selecting or not selecting incentives as is described above, a determination is made as to if shopping is complete. Such a determination is made based on any suitable conditions, such as a shopper selecting to move to a checkout area 140 discussed above, providing some type of “shopping complete” input on a user input, any other suitable technique or combinations of these. If shopping is determined to not be complete, processing returns to receiving user inputs to move through the store layout, at 604. If it is determined that shopping is complete, the shopper is able to checkout, at 632, and have the purchasing incentives selected by the shopper applied to the purchases. The shopper's profile is updated based upon the purchasing decisions and redemption of associated purchasing incentives, at 634. The process then ends.

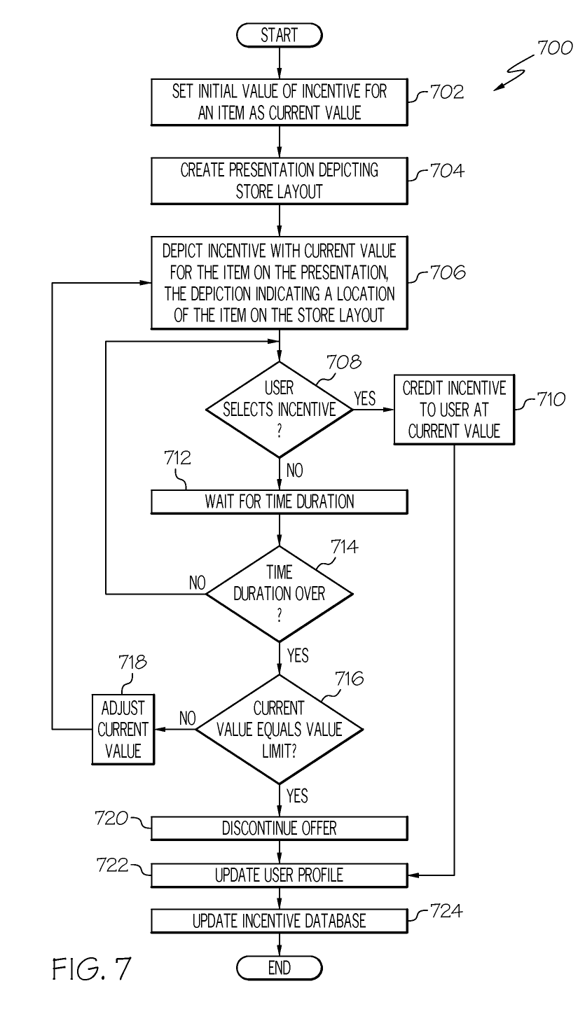

FIG. 7 illustrates a purchasing incentive value varying process 700, according to an example. The purchasing incentive value varying process 700 is an example of a process that displays time varying purchasing incentives, which are purchasing incentives that have a value that varies over time. In an example, purchasing incentives offered to shoppers are able to include one or more such time varying purchasing incentives. The purchasing incentive value varying process is able to vary the value of an offered purchasing incentive over time in order to achieve various results. In an example, the shopper's profile for a particular shopper is able to be refined by noting the value at which the shopper accepts the varying value purchasing incentive. Such information provides information regarding, for example, the shopper's price sensitivities. Aggregating such data over numerous shoppers, a better understanding can be obtained regarding the value to assign a purchasing incentive to improve acceptance while also restraining the cost of the incentive to the promoter.

The rate at which the value of a purchasing incentive is varied is able to be based on any suitable criteria. In an example, the value of a purchasing incentive for a perishable item, such as a food item or other perishable, is able to be increased as the expiration date approaches. As discussed above with regards to the purchasing incentive presentation system 400, each item is able to have an associated expiration date 448 that indicates a date after which the item will not be usable. In order to encourage shoppers to purchase items approaching their expiration dates, the value of a purchasing incentive is able to be increased based on a time proximity of the item's expiration date to a date of creation of the depiction of the value varying purchasing incentive. For example, the value of a purchasing incentive for an item is increased in the days before the expiration date for that item.

In another example, a purchasing incentive itself is able to be valid until a specified expiration time or date for the purchasing incentive. As that specified expiration time or date approaches, the value at which the purchasing incentive is offered to a shopper is able to be increased. As discussed above with regards to the purchasing incentive presentation system 400, each purchasing incentive is able to have an associated expiration date 467 that indicates when the purchasing incentive will no longer be honored. In order to encourage shoppers to select such time limited purchasing incentives, the value of a purchasing incentive is able to be increased based on a time proximity to a date of creation of a respective depiction to a respective expiration date of a respective purchase incentive depicted on the respective depiction. For example, the value of a purchasing incentive for an item is increased in the days before the expiration date for that purchasing incentive.

The purchasing incentive value varying process 700 sets, at 702, an initial value of the incentive. This initial value is set in this example as the current value, which will be varied as discussed below.

A presentation depicting the store layout is then created, at 704, and the purchasing incentive with the current value is also depicted with an indication of an item associated with the purchasing incentive, at 706. A determination is then made, at 708, if the user selects the purchasing incentive. If the user does select the purchasing incentive, the purchasing incentive at the present value is credited, at 710, to the shopper. The shopper's profile is then updated, at 722, and the incentive database is updated, at 724, in some examples to better allow for analysis of the values at which the purchasing incentive is accepted by many shoppers. The process then ends.

If a determination is made that the user does not select, at 708, the incentive, the process waits, at 712, for a time duration. The time duration is able to be any time duration selected to allow the shopper to see the value of the purchasing incentive, and to further ensure that the shopper will not accept the purchasing incentive at the current value. A determination is made, at 714, if the time duration is over. If the time duration is determined to not be over, the process returns to determining, at 708, if the user selects the purchasing incentive and waiting, at 712, for the duration.

Upon a determination, at 714, that the time duration is over, a determination is made as to whether the current value is the limit of the value at which the purchasing incentive is to be offered. Limits of the value are able to be, for example, a maximum discount value, a minimum price for an item, or any limit on the value of the purchasing incentive to be provided to the shopper. The limit of the value is able to be determined by, for example, the promoter of the purchasing incentive.

If the determination is that the current value is not the value limit, the value of the purchasing incentive is adjusted, at 718, and the process returns to depicting, at 706, the incentive with the current value, which has now been adjusted. If the current value is determined to be the limiting value, the offer is discontinued, at 720, and the user's profile is updated, at 722. The incentive database is also updated, at 724, to indicate the value at which the incentive was selected in order to, for example, analyze the acceptance of the offer at various values to determine a desired value at which to offer that incentive or similar purchasing incentives. The process then ends.

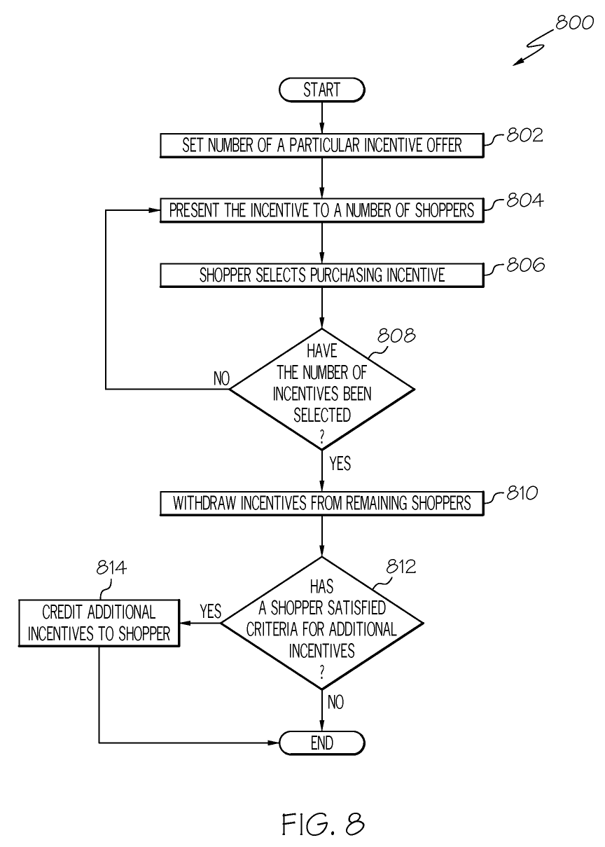

FIG. 8 illustrates a limited purchasing incentive offer process 800, according to an example. The limited purchasing incentive offer process 800 is an example of a process to enhance the attention which a purchasing incentive offer receives and also provides a gamification aspect to the purchasing incentive offer. In an example, the limited purchasing incentive offer process 800 offers a purchasing incentive but indicates that only a set number of shoppers are able to accept the offer. After that number of shoppers accepts the purchasing incentive, the purchasing incentive is no longer offered and therefore cannot be selected by a shopper. Limiting the number of shoppers that can receive the purchasing incentive serves to increase the urgency of selecting the offer, and can thereby cause some shoppers to more readily accept the offer and indicate their preferences for use in selecting purchasing incentives to offer them in the future.

The limited purchasing incentive offer process 800 begins by setting, at 802, a fixed number of a particular purchasing incentive to offer to shoppers. The fixed number to offer is able to be determined in some examples by various techniques, such as historical information regarding the number of similar purchasing incentives that were redeemed during previous offers, on marketing surveys, on other analyses, or combinations of these.

The incentives are presented, at 804, to a number of shoppers. In some examples, the number of shoppers to whom the particular purchasing incentives are offered is monitored to determine an acceptance rate of the offer. In some examples, the purchasing incentives that are offered in a limited, fixed number are offered to a large number of shoppers until the fixed number of purchasing incentives has been selected by the shoppers.

The purchasing incentives that are offered in a limited number are selected, at 806, by shoppers. Selecting a purchasing incentive is able to be performed by clicking on the purchasing incentive offer on a graphical user interface presenting the purchasing incentive, or by any other suitable technique. A determination is then made, at 808, if the fixed number of purchasing incentives has been selected by shoppers. If the fixed number has not yet been selected, the process returns to presenting, at 804, the incentive to a number of shoppers. If the fixed number of purchasing incentives has been selected by shoppers, the incentive is withdrawn, at 810, from the other shoppers.

### Information Processing System

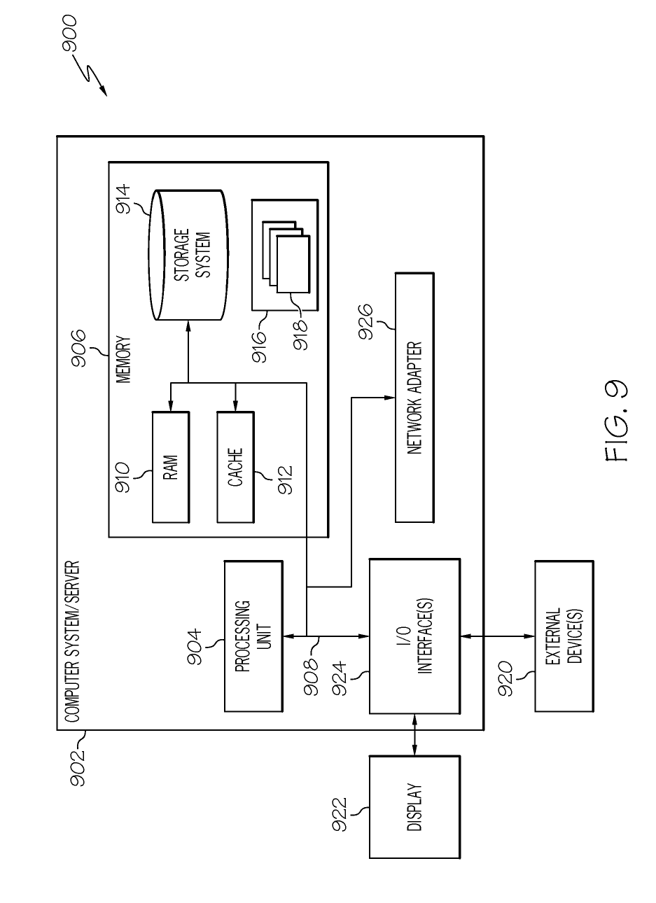

Referring now to FIG. 9, this figure is a block diagram illustrating an information processing system that can be utilized in various examples of the present disclosure. The information processing system 902 is based upon a suitably configured processing system configured to implement one or more embodiments of the present disclosure. Any suitably configured processing system can be used as the information processing system 902 in embodiments of the present disclosure. In another embodiment, the information processing system 902 is a special purpose information processing system configured to perform one or more embodiments discussed above. The components of the information processing system 902 can include, but are not limited to, one or more processors or processing units 904, a system memory 906, and a bus 908 that couples various system components including the system memory 906 to the processor 904.

The bus 908 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The system memory 906 can also include computer system readable media in the form of volatile memory, such as random access memory (RAM) 910 and/or cache memory 912. The information processing system 902 can further include other removable/non-removable, volatile/non-volatile computer system storage media. By way of example only, a storage system 914 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 908 by one or more data media interfaces. The memory 906 can include at least one program product having a set of program modules that are configured to carry out the functions of various examples described above.

Program/utility 916, having a set of program modules 918, may be stored in memory 906 by way of example, and not limitation, as well as an operating system, one or more application programs, other program modules, and program data. Each of the operating system, one or more application programs, other program modules, and program data or some combination thereof, may include an implementation of a networking environment. Program modules 918 generally carry out the functions and/or methodologies of the above described processes and systems.

The information processing system 902 can also communicate with one or more external devices 920 such as a keyboard, a pointing device, a display 922, and the like. The information processing system 902 is further able to communicate with one or more devices that enable a user to interact with the information processing system 902; and/or any devices (e.g., network card, modem, etc.) that enable computer system/server 902 to communicate with one or more other computing devices. Such communication can occur via I/O interfaces 924. Still yet, the information processing system 902 can communicate with one or more networks such as a local area network (LAN), a general wide area network (WAN), and/or a public network (e.g., the Internet) via network adapter 926. As depicted, the network adapter 926 communicates with the other components of information processing system 902 via the bus 908. Other hardware and/or software components can also be used in conjunction with the information processing system 902. Examples include, but are not limited to: microcode, device drivers, redundant processing units, external disk drive arrays, RAID systems, tape drives, and data archival storage systems.

### Non-Limiting Examples

As will be appreciated by one skilled in the art, aspects of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. I n the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for creating a presentation of purchase incentives to a shopper, the method comprising:
creating a presentation to present to a shopper;
depicting, on the presentation, a depiction of a store layout, the store layout depicting a plurality of areas, each area being associated with a respective set of items within a plurality of items offered for purchase; and
depicting, on the presentation with the depiction of the store layout, a respective depiction for each of at least one purchase incentive, each purchase incentive having a respective associated item within the plurality of items offered for purchase, the respective depiction being graphically linked to a respective area that is associated with the respective associated item.

2. The method of claim 1, the depicting for each of the at least one purchasing incentives comprising depicting at least one time varying purchasing incentive within a subset of all available purchasing incentives, each time varying purchasing incentive having a respective value varying with time, the value being based upon a time proximity of an expiration date for a respective item associated with the time varying purchasing incentive to a date of creation of the depiction.

3. The method of claim 1, further comprising:
determining a travel route for the shopper to follow through the store layout;
depicting the travel route on the presentation; and
presenting the presentation on an electronic display.

4. The method of claim 3, wherein the travel route is based upon a respective shopper profile associated with the shopper.

5. The method of claim 1, further comprising:
receiving user inputs indicating a shopper selected travel path through the store layout; and
updating, based upon the shopper selected travel path, shopper's preferences stored in a respective shopper profile associated with the shopper.

6. The method of claim 1, further comprising presenting the presentation on an electronic display;
receiving user input indicating a shopper interest a selected depiction of a purchase incentive; and
updating, based on the user input indicating the shopper interest, shopper's preference in a respective shopper profile associated with the shopper.

7. The method of claim 1, further comprising:
presenting the presentation on an electronic display;
adjusting a value of at least one time varying purchasing incentive within the at least one purchasing incentive; and updating, based on the value at a time of a user selection of the at least one time varying purchasing incentive, shopper's preference in a respective shopper profile associated with the shopper.
